(19) United States
(12) Patent Application Publication
(10) Pub. No.: US 2007/0246209 A1
(43) Pub. Date: Oct. 25, 2007

(54) CONTROL METHOD OF AIR-CONDITIONER FOR HYBRID ENGINE VEHICLE

(75) Inventors: Jeong Hoon LEE, Daejeon (KR); Young Kil Kim, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: HALLA CLIMATE CONTROL CORP., Daejeon (KR)

(21) Appl. No.: 11/736,626

(22) Filed: Apr. 18, 2007

(30) Foreign Application Priority Data
Apr. 18, 2006 (KR) 10-2006-0034857
Apr. 6, 2007 (KR) 10-2007-0034305

(51) Int. Cl. B60H 3/00; B60H 1/00

(52) U.S. Cl. 165/202; 165/42

(57) ABSTRACT

The present invention relates to a method of controlling an air-conditioning apparatus of a hybrid vehicle, the method comprises the first step (S101) of initiating the idle stop in which an engine is halted and a compressor is then operated by an electric motor; the second step (S102) of checking whether a value of cooling load or heating load is above the predetermined reference value or not; the third step for checking a discharge mode of the air-conditioning apparatus (S103) if a value of cooling load or heating load is above the predetermined reference value and controlling the air-conditioning apparatus to convert a mode into an external air mode (S108) if a value of cooling load or heating load is below the predetermined reference value; and the fourth step of controlling the air-conditioning apparatus to convert a mode into an external air mode (S108) if it is checked whether the specific mode in a plurality of discharge modes is selected and controlling the air-conditioning apparatus to convert a mode to an internal air mode (S107), if not.

### TECHNICAL FIELD

The present invention relates to a method of controlling an intake-mode in an air-conditioning apparatus of a hybrid vehicle, more particularly, to a method of controlling an air-conditioning apparatus of a hybrid vehicle which can determine an intake mode according to a temperature of external air when an engine is halted (that is, during an idle stop) to maintain satisfactorily a cooling capacity or to minimize a generation of fog and noise.

### BACKGROUND ART

In general, a hybrid vehicle utilizes an engine as well as an electrical motor as a driving source of the vehicle. That is, in a case where a vehicle is started or a large driving force is required, the vehicle uses the engine as the driving source, and in a case where a large driving source is not required (that is, when the vehicle is running on a level ground or an engine is halted), the vehicle uses the electric motor as the driving source. Such hybrid vehicle reduces an operating time of the engine using fossil fuel and causing an environmental pollution, and so the related technologies have been continuously developed and the hybrid vehicle is not in the research stage, but deployed on a commercial scale.

The air-conditioning apparatus of the hybrid vehicle is provided with a compressor for compressing refrigerant, this compressor is driven by the engine or the electric motor. At this time, in order to provide a driving capacity of the electric motor, which is equivalent to that of the engine, for driving the compressor, it is inevitable that the electric motor becomes bigger, and so there is a problem in that the large-sized electric motor can not arranged in an engine room. In general, the electric motor utilized in the hybrid vehicle is sized such that the electric motor can be arranged in the engine room.

As described above, since the small-sized electric motor is employed, refrigerant can not be sufficiently compressed by the compressor driven through the electric motor. Accordingly, in the hybrid vehicle, if the same cooling capacity can be obtained, there is need to minimize a power consumption of the compressor, and even if the electric motor generating a weak force is utilized for driving the compressor, the some cooling capacity should be secured.

As shown in FIG. 1, an air-conditioning apparatus of a conventional hybrid vehicle comprises a compressor 12 driven by an engine 11 or an electric motor (not shown) for compressing refrigerant; an electronic control unit (hereinafter, referred to as “engine ECU”) 10 for controlling the engine 11; an air-conditioning case 21 having a blower 23, an evaporator 22 and a heater core provided therein; an internal air/external air converting door 25 provided an upper side of the air-conditioning case 21 for supplying selectively external air and internal air; a temp door 26 provided at a front side of the heater core 24 to convert a flow passage of air passed through the evaporator 21; and an electronic control unit 20 (hereinafter, referred to as “ECU of the air conditioner”) for controlling the internal air/external air converting door 25 and the temp door 26 according to an external control signal and a signal of the engine ECU 10.

In the air-conditioning apparatus of the hybrid vehicle constructed as above, the engine ECU 10 transmits a signal to the ECU 20 of the air conditioner according to a driving speed of the engine 11 and the external signal, and the ECU 20 of the air conditioner operates the compressor 12 and the internal air/external air converting door 25 according to the external signal and the signal of the engine ECU 10 to intake-control.

As shown in FIG. 2, a conventional method of controlling an air-conditioning apparatus of the hybrid vehicle constructed as above comprises the steps of controlling the air-conditioning apparatus in the conventional manner if the vehicle is running; assuming that the engine is halted if a velocity of the vehicle is below a certain velocity and operating the internal air/external air converting door to fix a mode in the internal air mode; and operating the electric motor after the engine is completely halted.

The above conventional method of controlling the air-conditioning apparatus of the hybrid vehicle secures a sufficient cooling capacity in a case where a velocity of the vehicle is below a certain value or the engine is halted and does not generate operating noise of the internal air/external air converting door.

That is, once the ECU assumes that the engine will be halted on the basis a velocity of the vehicle, which is below the certain value, the ECU fixes the air-entering mode in the internal air mode, and so the internal air/external air converting door is not operated when the engine is halted. Accordingly, operating noise caused by a movement of the internal air/external air converting door is not generated, and a predetermined cooling capacity can be secured by circulating internal air although an electric motor generating a small driving force is utilized.

However, the above conventional method of controlling the air-conditioning apparatus of the hybrid vehicle has a problem in that, in a case where the engine is halted, the air-conditioning apparatus is controlled to convert the mode into the internal air mode so that a natural ventilation function is deteriorated, fog is generated due to the deteriorated ventilating function and operating noise of the blower is entered into the interior through an internal air entering port.

Accordingly, the method of controlling the air-conditioning apparatus of the hybrid vehicle which can prevent a generation of fog is proposed in Japanese laid-open publication No. 2003-118354, and the above method is as follow. As shown in FIG. 3, the above method comprises the steps of controlling conventionally the air-conditioning apparatus when the vehicle is running and controlling air-conditioning apparatus to covert an air-entering mode into an external air mode when the engine is halted.

In the above conventional method, if the engine is halted, the internal air entering port is closed, and so operating noise of the blower to be entered in the interior is intercepted and a generation of fog can be inhibited through a natural ventilation.

However, the above method of controlling the air-conditioning apparatus of the hybrid vehicle has a problem in that since air-conditioning is performed by using external, a cooling capacity is lowered due to an electric motor generating a small driving force if a temperature of external air is high.

In other word, the conventional method of controlling the air-conditioning apparatus of the hybrid vehicle has a problem in that, in a case where the engine is halted, any one of the internal air mode and the eternal air mode is selectively selected so that fog is generated and a noise of the blower is entered in an interior if the internal air mode is selected and a cooling capacity is lowered due to the electric motor generating a small driving force if the external air mode is selected.

### DISCLOSURE

### Technical Problem

The present invention is conceived to solve the aforementioned problem of the conventional technology, an object of the present invention is to provide a method of controlling an air-conditioning apparatus of a hybrid vehicle which can select and control automatically an internal air mode or an external air mode according a cooling load or heating load when an engine is halted (i.e., an idle stop) in a hybrid vehicle to solve the problem of generating fog or noise and to prevent a cooling capacity from lowering.

And, another object of the present invention is to provide a method of controlling an air-conditioning apparatus of a hybrid vehicle which can convert the mode into the external air mode when the cooling load or heating load is low and convert the mode into the internal air mode when the cooling load or heating load is high to inhibit a generation of fog and enhance a cooling capacity.

Further another object of the present invention is to provide a method of controlling an air-conditioning apparatus of a hybrid vehicle which intake-controls according to a status of the air-conditioning apparatus in a case where the idle stop is released in a hybrid vehicle and intake-controls to the external air mode in a case where a dehumidification mode is selected when the idle stop is released to enable fog to be removed.

### Technical Solution

In order to achieve the above objects, the method of controlling an air-conditioning apparatus of a hybrid vehicle comprising an air-conditioning case having an evaporator and a heater core provided therein and a defrost vent, a face vent and a floor vent formed at an outlet side thereof, comprises the first step (S101) of initiating the idle stop in which an engine is halted and a compressor is then operated by an electric motor; the second step (S102) of checking whether a value of cooling load or heating load is above the predetermined reference value or not; the third step for checking a discharge mode of the air-conditioning apparatus (S103) if a value of cooling load or heating load is above the predetermined reference value and controlling the air-conditioning apparatus to convert an intake mode into an external air mode (S108) if a value of cooling load or heating load is below the predetermined reference value; and the fourth step of controlling the air-conditioning apparatus to convert an intake mode into an external air mode (S108) if it is checked whether the specific mode in a plurality of discharge modes, which are set for making one or more vents of a plurality of vents open for controlling a cooling/heating operation in an interior of the vehicle by controlling an amount and a temperature of air discharged to each vent of the air-conditioning apparatus, is selected and controlling the air-conditioning apparatus to convert a mode to an internal air mode (S107), if not.

Also, the specific mode in the fourth step is any one selected from a floor mode, a mix mode or a defrost mode.

In addition, the fourth step consists of; the fourth-1 step of controlling the air-conditioning apparatus to convert an intake mode into the external air mode (S108) if it is checked that the specific mode is selected, and checking whether the idle stop is released or not (S104), if not; and the fourth-2 step of performing an intake control of the air-conditioning apparatus according to an intake mode selected by a passenger if the idle stop is released and controlling the air-conditioning apparatus to convert an intake mode into the internal air mode (S107), if not.

Further, the value of the cooling load or the heating load is an absolute value of T_{d} determined by the following equation.
T_{d}=A·Tₛₑₜ+B·Tᵢₙ+C·Tₒᵤₜ+D·Sun+E

(wherein, “A” to “D” are coefficients, “E” is an offset, “Tₛₑₜ” is a temperature set by the passenger, “Tᵢₙ” is a cabin temperature of the vehicle, “Tₒᵤₜ” is a temperature of external air and “Sun” is amount of solar radiation load)

On the other hand, the value of the cooling load or the heating load is determined by a temperature of external air Tₒᵤₜ.

Furthermore, it is checked whether the internal air mode is selected or not (S105) in a state where the idle stop is released, and the air-conditioning apparatus is controlled to convert the intake mode to the external air mode (S108) if the discharge mode is the mix mode or the defrost mode in which air is discharged to a windshield of the vehicle (S106) although the internal air mode is selected by a passenger.

### Advantageous Effects

According to the method of controlling an air-conditioning apparatus of a hybrid vehicle according to the present invention mentioned above, the internal air mode or the external air mode can be automatically selected and controlled according a cooling load or heating load when an engine is halted (i.e., an idle stop) of the hybrid vehicle, and so there is an advantage in that the problem of generating fog or noise is solved and it is possible to prevent a cooling capacity from lowering.

Also, according to the method of controlling an air-conditioning apparatus of a hybrid vehicle according to the present invention, there is the advantage in that the mode is converted into the external air mode when the cooling load or heating load is small and is converted into the internal air mode when the cooling load or heating load is large to inhibit a generation of fog and enhance a cooling capacity.

Further, the present invention has an advantage in that An intake-control is performed according to a status of the air-conditioning apparatus in a case where the idle stop is released in the hybrid vehicle and a control is performed to convert the intake mode into the external air mode in a case where a dehumidification mode is selected when the idle stop is released to enable fog to be removed.

### DESCRIPTION OF DRAWINGS

The above and other objects, features and advantages of the present invention will become apparent from the following description of preferred embodiments given in conjunction with the accompanying drawings, in which:

FIG. 1 is a structural view showing a part of an air-conditioning apparatus of a conventional hybrid vehicle;

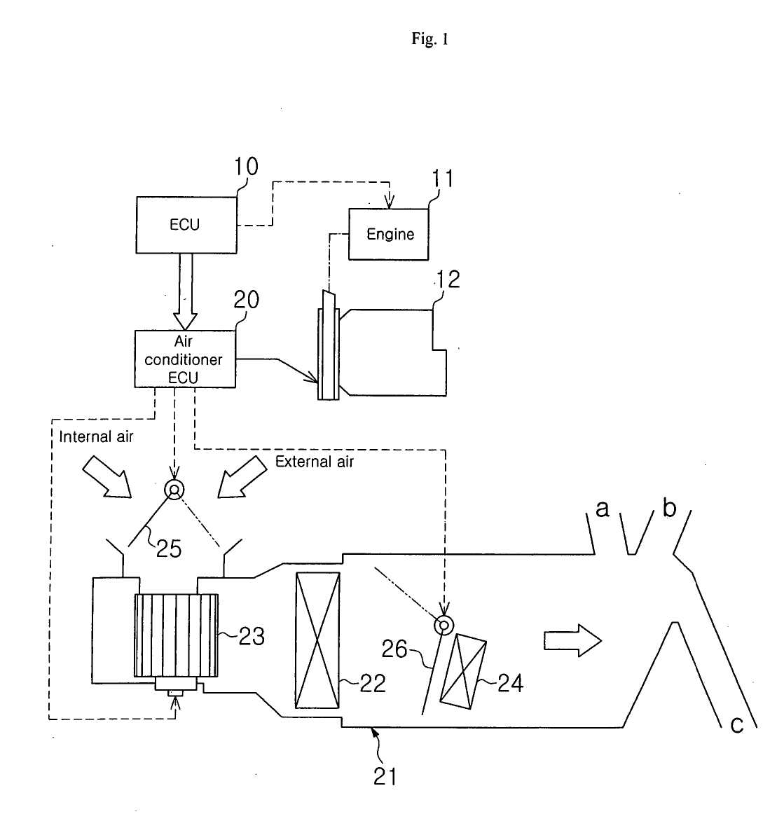

FIG. 2 is a flow chart illustrating one embodiment of a method of controlling an air-conditioning apparatus of a conventional hybrid vehicle;

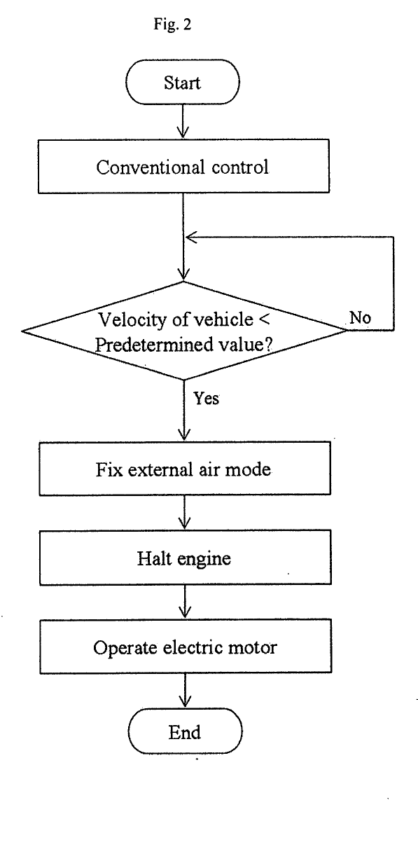

FIG. 3 is a flow chart illustrating another embodiment of a method of controlling an air-conditioning apparatus of a conventional hybrid vehicle;

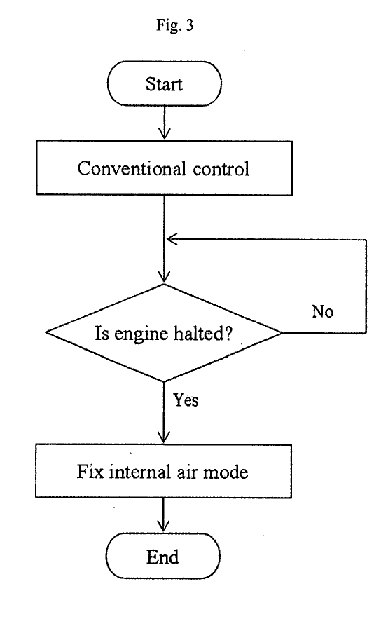

FIG. 4 is a flow chart illustrating one embodiment of a method of controlling an air-conditioning apparatus of a hybrid vehicle according to the present invention;

FIG. 5 is a flow chart illustrating another embodiment of a method of controlling an air-conditioning apparatus of a hybrid vehicle according to the present invention; and

FIG. 6 is a graph for illustrating a concept of a cooling load or heating load.

### BEST MODEL

Hereinafter, the method of controlling an air-conditioning apparatus in a hybrid vehicle of the present invention will be described in detail with reference to accompanying drawings.

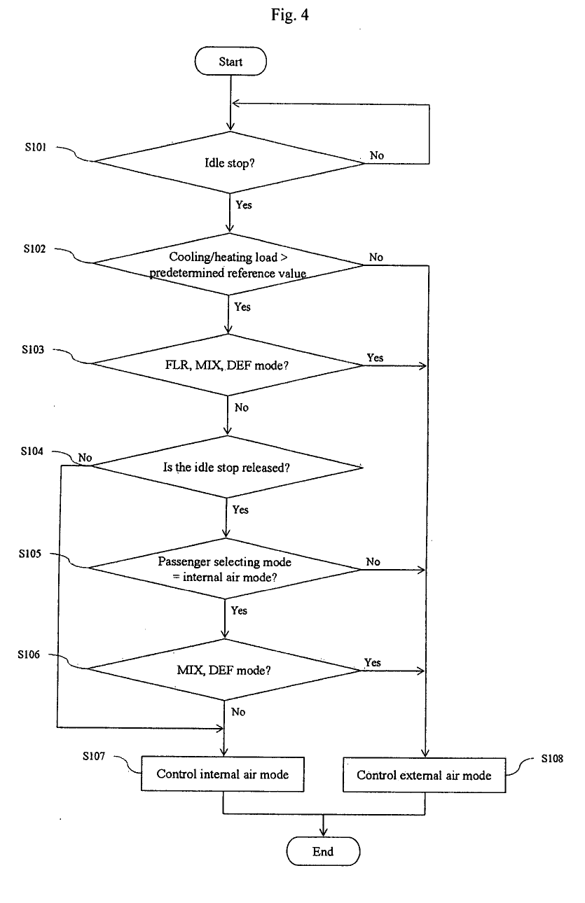

FIG. 4 is a flow chart illustrating one embodiment of a method of controlling an air-conditioning apparatus of a hybrid vehicle according to the present invention. For reference, in a hybrid vehicle, if a velocity is lowered below a predetermined value, an engine is halted for saving the energy and an electric motor is then operated. The above state is called as “idle-stop mode”. If such idle stop is initiated, a compressor is also driven by the electric motor.

According to one embodiment of the method of controlling the air-conditioning apparatus of the hybrid vehicle of the present invention, the method comprises the first step (S101) of initiating the idle stop in which the engine is halted and the compressor is then operated by the electric motor; the second step (S102) of checking whether a value of cooling load or heating load is above the predetermined reference or not; the third step of checking a discharge mode of the air-conditioning apparatus (S103) if a value of cooling load or heating load is above the predetermined reference and controlling the air-conditioning apparatus to convert a mode into an external air mode (S108) if a value of cooling load or heating load is below the predetermined reference; the fourth step of controlling the air-conditioning apparatus to convert a mode into the external air mode (S108) if the discharge mode is a floor mode or a mix mode or a defrost mode and checking whether the idle stop is released or not (S104), if not; and the fifth step of performing an intake control of the air-conditioning apparatus according to an intake mode selected by a passenger if the idle stop is released and controlling the air-conditioning apparatus to convert a mode into the internal air mode (S107), if not.

Here, in a state where the idle stop is released, although the internal air mode is selected by the passenger, If the discharge mode is the mix mode or the defrost mode (S106) in which air is discharged toward a windshield of the vehicle, it is checked whether the internal air mode is selected or not (S105) to perform an intake control (S108) to convert a mode into the external air mode For reference, the discharge mode of the air-conditioning apparatus for the vehicles is classified into a defrost (DEF) mode, a mix mode, a face mode, a floor (FLR) mode and a bi-level (B/L) mode on the basis of a discharging direction. In the defrost mode, air is discharged from a discharge port located a lower side of a front windshield toward the front windshield. And, in the mix mode, air is discharged toward the front windshield as well as the passenger. In addition, in the face mode, air is discharged toward an upper part of the body of the passenger, and air is discharged toward a lower part of the body of the passenger in the floor mode. And, in the bi-level mode, air is discharged toward upper and lower parts of the body of the passenger.

For reference, the cooling load or heating load is described below. In order to perform effectively a cooling or heating operation in the vehicle, various conditions such as a temperature of external air, a cabin temperature of the vehicle, amount of solar radiation load, a temperature set by the passenger and the like should be synthetically considered. For example, in a case where a cooling operation is performed, on the basis of whether a temperature of external air is higher than any reference temperature or not, it is possible to judge that a cooling operation will be performed. However, although a temperature of external air is higher, an interior of the vehicle may become already a low temperature state or a cooling operation may be necessarily required because a cabin temperature of the vehicle is high. In the latter, it is natural to perform a cooling operation. In the former, however, the energy is wasted and the passenger may feel a chill due to a cooling operation. Considering various situations as described above, it is desirable that the various variables described above are synthesized to calculate amount of the cooling load and an amount of the heating load and the heating operation is then performed according to the above calculation results.

Preferably, the cooling load or heating load is calculated as the following equation;
T_{d}=A·Tₛₑₜ+B·Tᵢₙ+C·Tₒᵤₜ+D·Sun+E

In the above equation, “A” to “D” are coefficients which are appropriately determined, and “E” is an offset value. Also, “T_{d}” is a cooling load or a heating load, “Tₛₑₜ” is a temperature set by the passenger, “Tᵢₙ” is a cabin temperature of the vehicle, “Tₒᵤₜ” is a temperature of external air, “Sun” is amount of solar radiation load.

Explaining qualitatively the above equation, it is obvious that the larger a difference between the temperature Tₛₑₜ set by the passenger and the cabin temperature Tᵢₙ of the vehicle or a difference between the temperature Tₒᵤₜ of external air and the cabin temperature Tᵢₙ of the vehicle or amount (Sun) of solar radiation load becomes, the larger the cooling load or the heating load is. Accordingly, there is a need to lower or raise a temperature of air discharged to an interior of the vehicle through the air-conditioning apparatus.

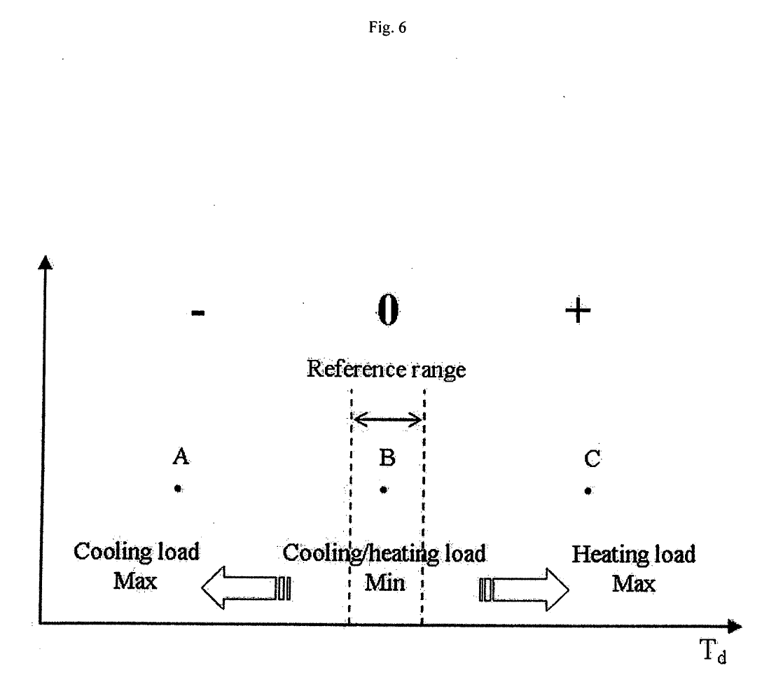

FIG. 6 is a graph illustrating a distribution reference of required amount of cooling load and the heating load. As shown in the drawing, the smaller a value of T_{d} is in a negative (−) area, the larger the required amount of cooling load becomes, and the larger a value of T_{d} is in a positive (+) area, the larger the required amount of heating load becomes. In addition, if a value of T_{d} is within the approximately reference range, the required amount of cooling load or heating load is maintained at zero (0) so as to prevent the cooling or heating operation from performing. The cooling load or heating load is an absolute value of T_{d}, in a case where the value of T_{d} leans to (−) area (i.e., the required amount of cooling load is increased, for example, the required amount of cooling load is a value of A point in FIG. 6), or in a case where the value of T_{d} leans to (+) area (i.e., the required amount of heating load is increased, for example, the required amount of cooling load is a value of C point in FIG. 6), the cooling load or heating load is increased. In a case where the value of T_{d} is within a reference range shown in FIG. 6 (for example, the required amount of cooling load is a value of B point in FIG. 6), the cooling load or heating load is zero (0). The reference range can be determined appropriately by the experimental and empirical methods for convenience sake.

When the idle stop is entered or the idle stop is released, the method of controlling the air-conditioning apparatus of the hybrid vehicle constructed as describe above can secure a sufficient cooling capacity through an intake-control in a case where the cooling load or heating load is large and can inhibit a generation of fog through an intake-control in a case where the cooling load or heating load is small.

Once the idle stop is performed (S101), the cooling load or heating load is sensed to verify whether the cooling load or heating load is above the reference value (S102). If the cooling load or heating load is below the reference value, a mode of the air-conditioning apparatus is converted into the external air mode (S108), and If the cooling load or heating load is above the reference value, a discharge mode of the air-conditioning apparatus is checked (S103), With this, if the value of the cooling load or heating load is large, the mode of the air-conditioning apparatus is converted into the internal air mode, and so it is possible to solve the problem of generating fog due to a lower of natural ventilation function.

When the cooling load or heating load is above the reference value, the discharge mode is checked (S 103). If the discharge mode is the floor mode, the mix mode or the defrost mode, the mode of the air-conditioning apparatus is converted into the external air mode (S108), and If the discharge mode is the mode except the above mentioned modes, it is checked whether the idle stop is released or not (S104). The discharge mode is the floor (FLR) mode, when the air-conditioning apparatus is not operated, it is the most vulnerable to a generation of frost, and the user can determine the mix mode or the defrost mode as the selection mode for removing the fog. Accordingly, in a case of the specific discharge mode as described above, the mode of the air-conditioning apparatus is compulsorily converted into the external air mode. That is, the mode of the air-conditioning apparatus is compulsorily converted into the external air mode so as to prevent a generation of the fog.

Further, in a case where the discharge mode is not the floor/mix/defrost mode, if the idle stop is not released, that is, the idle stop is maintained, the mode of the air-conditioning apparatus is converted into the internal air mode (S107), and if the idle stop is released, a control state of the air-conditioning apparatus is checked. That is, the intake mode and the discharge mode are checked (S105), if the air-conditioning apparatus is in the external air mode, the mode is converted into the external air mode (S108), and if the air-conditioning apparatus is in the internal air mode, the discharge mode is checked. At this time, in a case where the discharge mode is a dehumidification mode, that is, the mix mode or the defrost mode, the mode is converted into the external air mode (S108), and the mode is converted into the internal air mode (S107), if not.

In other word, in a state where the idle stop is released, although the user selects the internal air mode, if the discharge mode is the dehumidification mode, the mode is controlled to convert the intake mode into the external air mode.

Accordingly, although the cooling load or heating load is below the reference value and above the reference value, in a case where the discharge mode is the mix/defrost mode, the air-conditioning apparatus is operated with the external air mode, and so a generation of the fog is inhibited and noise generated in a blower is not entered in an interior of the vehicle. In addition, in a case where the cooling load or heating load is above the reference value and the discharge mode is the floor/mix/defrost mode, the air-conditioning apparatus is operated with the internal air mode, and so a cooling/heating capacity is enhanced.

Also, if the idle stop is released, although a state of the air-conditioning apparatus is in the internal air mode, if the discharge mode corresponds to the dehumidification mode, the air-conditioning apparatus is controlled to covert the mode into the external air mode for removing fog.

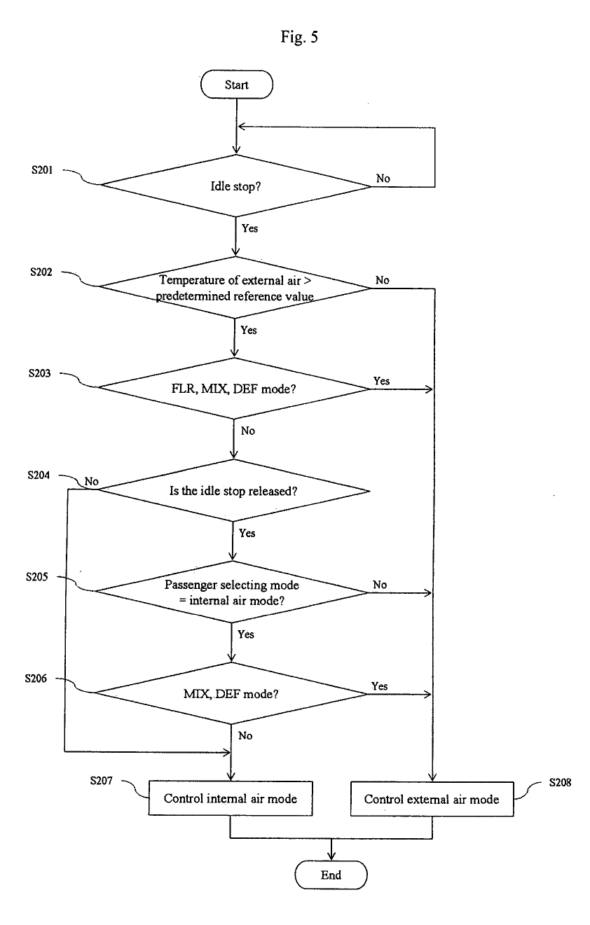

FIG. 5 is a flow chart illustrating another embodiment of the method of controlling the air-conditioning apparatus of the hybrid vehicle according to the present invention.

According to the another embodiment of the method of controlling the air-conditioning apparatus of the hybrid vehicle according to the present invention, the method comprises the first step (S201) of initiating the idle stop in which the engine is halted and the compressor is then operated by the electric motor; the second step (S202) of sensing a temperature of external air to verify whether a temperature of external air is above 15□ or not; the third step for checking a discharge mode of the air-conditioning apparatus (S203) if a temperature of external air is above 15° C., and controlling the air-conditioning apparatus to convert a mode into an external air mode (S208) if a temperature of external air is below 15° C.; the fourth step of controlling the air-conditioning apparatus to convert a mode into an external air mode (S208) if the discharge mode of the air-conditioning apparatus is a floor mode or a mix mode or a defrost mode, and checking whether the idle stop is released or not, if not (S204); and the fifth step of performing an intake control of the air-conditioning apparatus according to an intake mode selected by a passenger if the idle stop is released and controlling the air-conditioning apparatus to convert a mode into an internal air mode (S207), if not.

Here, in a state where the idle stop is released, it is checked whether the internal air mode is selected or not (S205), although the internal air mode is selected by the passenger, the air-conditioning apparatus is controlled to convert an intake mode into the external air mode (S208) if the discharge mode is the mix or defrost mode in which air is discharged toward a windshield of the vehicle.

That is, for calculating the cooling load or heating load, this present embodiment utilizes only a temperature value of external air. Accordingly, this embodiment can embody the simpler control logic through the above principle. It is preferred that approximately 15□ is determined as the temperature reference of external air. However, a value which is convenient for the design or an appropriate value obtained experimentally when it is practically applied may be determined as the temperature reference of external air.

### INDUSTRIAL APPLICABILITY

In the above, the preferred embodiment of the present invention is illustrated. However, the scope of the present invention is not limited to the specific embodiments described above and the scope of the present invention is determined and defined only by the appended claims. Further, those skilled in the art can make various changes and modifications thereto without departing from its true spirit. Therefore, various changes and modifications obvious to those skilled in the art will fall within the scope of the present invention.

1. A method of controlling an air-conditioning apparatus of a hybrid vehicle comprising an air-conditioning case having an evaporator and a heater core provided therein and a defrost vent (a), a face vent(b) and a floor vent(c) formed at an outlet side thereof, comprising;
the first step (S101) of initiating the idle stop in which an engine is halted and a compressor is then operated by an electric motor;
the second step (S102) of checking whether a value of cooling load or heating load is above the predetermined reference value or not;
the third step for checking a discharge mode of the air-conditioning apparatus (S103) if a value of cooling load or heating load is above the predetermined reference value and controlling the air-conditioning apparatus to convert an intake mode into an external air mode (S108) if a value of cooling load or heating load is below the predetermined reference value; and
the fourth step of controlling the air-conditioning apparatus to convert an intake mode into an external air mode (S108) if it is checked whether the specific mode in a plurality of discharge modes, which are set for making one or more vents of a plurality of vents open for controlling a cooling/heating operation in an interior of the vehicle by controlling an amount and a temperature of air discharged to each vent of the air-conditioning apparatus, is selected and controlling the air-conditioning apparatus to convert a mode to an internal air mode (S107), if not.

2. The method of controlling the air-conditioning apparatus in the hybrid vehicle according to claim 1, wherein the specific mode in the fourth step is any one selected from a floor mode, a mix mode or a defrost mode.

3. The method of controlling the air-conditioning apparatus in the hybrid vehicle according to claim 2, wherein the fourth step consists of;
the fourth-1 step of controlling the air-conditioning apparatus to convert an intake mode into the external air mode (S108) if it is checked that the specific mode is selected, and checking whether the idle stop is released or not (S104), if not; and
the fourth-2 step of performing an intake control of the air-conditioning apparatus according to an intake mode selected by a passenger if the idle stop is released and controlling the air-conditioning apparatus to convert an intake mode into the internal air mode (S107), if not.

4. The method of controlling the air-conditioning apparatus in the hybrid vehicle according to claim 3, wherein the value of the cooling load or the heating load is an absolute value of T_{d} determined by the following equation.
T_{d}=A·Tₛₑₜ+B·Tᵢₙ+C·Tₒᵤₜ+D·Sun+E
(wherein, “A” to “D” are coefficients, “E” is an offset, “Tₛₑₜ” is a temperature set by the passenger, “Tᵢₙ” is a cabin temperature of the vehicle, “Tₒᵤₜ” is a temperature of external air and “Sun” is amount of solar radiation load)

5. The method of controlling the air-conditioning apparatus in the hybrid vehicle according to claim 3, wherein the value of the cooling load or the heating load is determined by a temperature of external air T_{d}.

6. The method of controlling the air-conditioning apparatus in the hybrid vehicle according to claim 3, wherein it is checked whether the internal air mode is selected or not (S105) in a state where the idle stop is released, and the air-conditioning apparatus is controlled to convert the intake mode to the external air mode (S108) if the discharge mode is the mix mode or the defrost mode in which air is discharged to a windshield of the vehicle (S106) although the internal air mode is selected by a passenger.
